(19) United States
(12) Patent Application Publication
(10) Pub. No.: US 2024/0425680 A1
(43) Pub. Date: Dec. 26, 2024

(54) BIODEGRADABLE POLYMER BASED BIOCOMPOSITES

(71) Applicant: CTK RESEARCH AND DEVELOPMENT CANADA LTD., Surrey (CA)

(72) Inventors: Tizazu H. MEKONNEN, Waterloo, Ontario (CA); Arvind GUPTA, Waterloo, Ontario (CA)

(21) Appl. No.: 18/699,343

(22) PCT Filed: Oct. 19, 2022
(86) PCT No.: PCT/CA2022/051543

§ 371 Date: Apr. 8, 2024

Related U.S. Application Data
(60) Provisional application No. 63/257,478, filed on Oct. 19, 2021.

(51) Int. Cl. C08L 1/02; C08L 67/04

(52) U.S. Cl. CPC C08L 1/02; C08L 67/04; C08L 2201/06; C08L 2205/025; C08L 2205/035; C08L 2205/16

(57) ABSTRACT

The present invention provides compositions for making biodegradable biocomposites, comprising poly(3-hydroxybu-tyrate-co-3-hydroxyvalerate) (PHBV) or a mixture of PHBV and polybutylene adipate terephthalate (PBAT); a hemp residue; and optionally PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or one or more compatibilizers from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

### FIELD OF THE INVENTION

The present invention pertains to the field of biodegradable polymeric material. In particular, it relates to biocomposites comprising poly(3-hydroxybutyrate-co-3-hydroxyvalerate) (PHBV) based, and method of making same.

### BACKGROUND OF THE INVENTION

Plastics have contributed a significant role in the development of human society in the last century. Conventional polymers such as polyolefins, used in mainly single-use applications, accumulates in the environment after disposal [1]. The existence of these polymers for a long time has contaminated our land, water and air leading to environmental and public health crises which marks such polymers as non-suitable for applications in which plastics are used for a short period and get discarded [2, 3].

Recycling can be a plausible option however, contamination of plastic packages and properties depletion during melt processing makes mechanical recycling costlier and unfeasible [4].

Polymers derived from plants and microorganisms (i.e. biobased) are biodegradable as they are susceptible to enzymatic action of microorganisms and hydrolysis [5]. Increased demand for renewable polymers has compelled governments and legislative bodies worldwide to frame laws/policies to ban single-use conventional plastics and promote alternate renewable plastics [6].

Poly(3-hydroxybutyrate-co-3-hydroxyvalerate) (PHBV) is a biobased-biodegradable thermoplastic directly derived from microorganisms that has shown promising properties to replace single-use plastics for a range of applications. In addition to its biodegradability, PHBV has competitive mechanical properties to a range of commodity plastic, making it appealing for food packaging and consumer goods applications. However, it is substantially more expensive than conventional plastics and its brittleness hinders it from extensive applications.

Use of natural fillers such as hemp fibers, cellulose nanocrystals, hydroxyapatite wheat straw fibers, wood and wood flour, waste coffee, agave fibers, lignin, miscanthus fibers, chitin, soy hull, distiller's dried drains, and other agro-residues has been explored by numerous researches to form polymer based composites

It is well known that the incorporation of natural fillers in renewable polymers restricts the polymer chain mobility and increases the melt viscosity and may limit melt processing of biocomposites.

Therefore there is a need for cost-competitive, biodegradable materials having desired mechanical and/or thermomechanical properties and processability that can be prepared from biodegradable polymers and sustainable, low cost, and biodegradable fillers, for replacing conventional plastics.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide biodegradable biocomposites based on poly(3-hydroxybutyrate-co-3-hydroxyvalerate) (PHBV).

In accordance with an aspect of the present invention, there is provided a composition for use in making a biodegradable composite material, the composition comprises: a) about 30 to about 99.5 wt % of a polymer-component comprising poly(3-hydroxybutyrate-co-3-hydroxyvalerate) (PHBV) or a mixture of PHBV-polybutylene adipate terephthalate (PBAT); b) about 0.5 to about 60 wt % of hemp residue; and c) optionally about 0.1 to 50 wt % of PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

In accordance with an aspect of the present invention, there is provided a biocomposite material comprising a blend of: a) about 30 to about 99.5 wt % of a polymer-component comprising Poly(3-hydroxybutyrate-co-3-hydroxyvalerate) (PHBV) or a mixture of PHBV-polybutylene adipate terephthalate (PBAT); b) about 0.5 to about 60 wt % of hemp residue; and c) optionally about 0.1 to 50 wt % of PBAT grafted with one or more compatibilizers selected from maleic anhydride, glycidyl methacrylate, pyromellitic anhydide, acrylic acid, polyacrylic acid, methylene diphenyl diisocyanate, poly(glycidyl methacrylate, copolymer(s) of glycidyl methacrylate and copolymers of acrylic acid, and/or one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

In accordance with an aspect of the present invention, there is provided a method of preparing a biocomposite material as described herein. The method comprises: a) admixing the polymer-component with hemp residue, and optionally with the compatibilizer and/or the compatibilizer-grafted PBAT, and b) heating the admixture at a temperature sufficient to melt at least the PHVB and/or PBAT.

### BRIEF DESCRIPTION OF THE FIGURES

Further features and advantages of the present disclosure will become apparent from the following detailed description, taken in combination with the appended drawings, in which:

FIG. 1 depicts the results of tensile testing and tensile modulus of the exemplary biocompsites in accordance with embodiments of the present invention.

FIG. 2 depicts elongation at break and tensile resistance of the exemplary biocomposites in accordance with the embodiments of the present invention.

FIGS. 3A and 3E depict storage modulus and tan delta, respectively of exemplary PHBV-hemp residue biocomposites against temperature in accordance with the embodiments of the present invention.

FIGS. 4A and 4B depict storage modulus and tan delta, respectively of exemplary PHBV-PBAT-hemp residue biocomposites against temperature in accordance with the embodiments of the present invention.

FIGS. 5A and 5B depict storage modulus and tan delta, respectively of exemplary PHBV-PBAT-mPBAT-hemp residue biocomposites against temperature in accordance with the embodiments of the present invention.

FIG. 6 depicts heat deflection temperature of the exemplary PHBV-hemp residue biocomposites, and PHBV-PBAT-hemp residue biocomposites without and with mPBAT in accordance with the embodiments of the present invention.

FIGS. 7A-7C depicts rheological properties of PHBV-hemp residue biocomposites in accordance with embodiments of the present invention. FIG. 7A depicts storage modulus, FIG. 7B depicts loss modulus, and FIG. 7C depicts complex viscosity.

FIGS. 8A-8C depicts rheological properties of PHBV-PBAT-hemp residue biocomposites in accordance with embodiments of the present invention. FIG. 8A depicts storage modulus, FIG. 8B depicts loss modulus, and FIG. 8C depicts complex viscosity.

FIGS. 9A-9C depicts rheological properties of PHBV-PBAT-hemp residue biocomposites with mPBAT in accordance with embodiments of the present invention. FIG. 9A depicts storage modulus, FIG. 9B depicts loss modulus, and FIG. 9C depicts complex viscosity.

FIGS. 10A-10D depict water absorption of PHVB and the exemplary biocomposites in accordance with the embodiments of the present invention against time in days.

FIGS. 11A-11D depicts morphological analysis of the exemplary PBAT-hemp residue biocomposites in accordance with the embodiments of the present invention.

FIGS. 12A-12D depicts morphological analysis of the exemplary PHBV-PBAT-hemp residue biocomposites in accordance with the embodiments of the present invention.

FIGS. 13A-13C depicts morphological analysis of the exemplary PHBV-PBAT-hemp residue biocomposites with mPBAT in accordance with the embodiments of the present invention.

FIGS. 14A-14C depicts morphological analysis of the exemplary biocomposites of (a) PHBV, (b) (80:20-PHBV:PBAT) and (c) (80:20)-M with 30% hemp residue in accordance with the embodiments of the present invention.

### DETAILED DESCRIPTION OF THE INVENTION

Unless defined otherwise, all technical and scientific terms used herein have the same meaning as commonly understood by one of ordinary skill in the art to which this invention belongs.

The articles “a” and “an” are used herein to refer to one or to more than one (i.e., to at least one) of the grammatical object of the article. By way of example, “an element” means one element or more than one element.

As used herein, the term “about” refers to a +/−10% variation from the nominal value. It is to be understood that such a variation is always included in a given value provided herein, whether or not it is specifically referred to.

As used herein, the term “hemp residue” (HP), refers to ground hemp stalk wherein the hemp hurd and/or fibers are ground and/or sliced into micron size particles. The residue can be in the form of powder or dust.

As used herein, the term “biodegradable” refers to a material that degrades or breaks down upon exposure to sunlight or ultra-violet radiation, water or dampness, microorganisms such as bacteria and fungi, enzymes or wind abrasion.

As used herein, the term “bio-based” refers to a material made from substances derived from living (or once-living) organisms.

The present invention relates to novel compositions for making poly(3-hydroxybutyrate-co-3-hydroxyvalerate) (PHBV) based biodegradable biocomposite, and the biodegradable biocomposite materials formed from these compositions.

The biocomposite materials of the present invention can exhibit improved tensile modulus, and similar tensile strength and heat deflection in comparison to the pristine PHBV, making them potential candidate of consumer goods, rigid packaging application, and additive manufacturing.

In one aspect, the present invention provides a composition for use in making a biodegradable biocomposite material, the composition comprises: a) about 30 to about 99.5 wt % of a polymer-component comprising poly(3-hydroxybutyrate-co-3-hydroxyvalerate) (PHBV), or a mixture of PHBV and polybutylene adipate terephthalate (PBAT); b) about 0.5 to about 60 wt % of hemp residue; and c) optionally about 0.1 to 50 wt % of PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

In another aspect, the present invention provides a biodegradable biocomposite material, which comprises a blend of about 30 to about 99.5 wt % of a polymer-component comprising poly(3-hydroxybutyrate-co-3-hydroxyvalerate) (PHBV), or a mixture of PHBV and polybutylene adipate terephthalate (PBAT); about 0.5 to about 60 wt % of hemp residue; and optionally about 0.1 to 50 wt % of PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

In some embodiments, the polymer-component is poly(3-hydroxybutyrate-co-3-hydroxyvalerate) (PHBV).

In some embodiments, the polymer-component is a mixture of PHBV and polybutylene adipate terephthalate (PBAT).

In some embodiments, the PHBV-PBAT mixture comprises about 10 wt %-about 90 wt % of PHBV and about 90 to about 10 wt % of PBAT by total weight of the blend.

In some embodiments, the PHBV-PBAT mixture comprises about 50-about 90 wt % of PHBV and about 50 to about 10 wt % of PBAT by total weight of the blend.

In some embodiments, the PHBV-PBAT mixture comprises about 70-about 90 wt % of PHBV and about 30 to about 10 wt % of PBAT by total weight of the blend.

In some embodiments, the composition or composite comprises about 40-90% PHBV-component and about 10-60% HP.

In some embodiments, the composition and/or biocomposite material of the present invention comprises one or more compatibilizers selected from maleic anhydride, pyromellitic anhydride, acrylic acid; polyacrylic acid, methylene diphenyl diisocyanate, and copolymers of acrylic acid.

In some embodiments, the composition and/or biocomposite material of the present invention comprises one or more compatibilizers selected from maleic anhydride, glycidyl methacrylate, pyromellitic anhydride and methylene diphenyl diisocyanate.

In some embodiments, the composition and/or the biocomposite material of the present invention comprises PBAT grafted with one or more of maleic anhydride, glycidyl methacrylate, pyromellitic anhydride and acrylic acid.

In some embodiments, the composition and/or the biocomposite material of the present invention comprises about 5% to 20% wt % of the PBAT grafted with the one or more compatibilizers.

The hemp residue of the present invention can be prepared by milling and/or grinding the hemp stalk to obtain micron size particles. In some embodiments, hemp residue comprises ground hemp hurd and bast fibers. In some embodiments, the hemp residue is primarily composed of the hemp core and residual bast fibers. In some embodiments, the hemp residue is composed of hemp hurd. In some embodiments, the residue is in the form of a powder.

In some embodiments, before milling or grinding, the hemp stalk fiber is washed with about 2-10% solution of sodium hydroxide in water (1 part stalk per 10 parts solution by weight), and then dried.

In some embodiments, the hemp residue comprises particles having length about 75 to 150 μm and an aspect ratio of about 3.5 to 5. In some embodiments, the hemp residue has density about 1.0 to 2.0 g/cm³.

In some embodiments, the hemp residue comprises about 60-75% cellulose, 5-15% hemicellulose and about 10-25% lignin.

In some embodiments, the hemp residue is treated to remove tetrahydrocannabinol (THC) & cannabidiol (CBD).

In one embodiment, the composition and/or the biocomposite material of the present invention comprises about 30 wt % of PHBV-PBAT blend, about 60 wt % HP residue, and about 10 wt % PBAT grafted with maleic anhydride.

In some embodiments, composition and/or the biocomposite material comprises about 1 to about 3% by weight of a processing agent, such as glycerol monostearate, and strearic acid.

In some embodiments, composition and/or the biocomposite material comprise one or more inorganic fillers (such as, talc, clay, wollastonite, montmorillonite, or carbonate, bicarbonate, oxide or sulfate of alkali metal or alkali earth metal).

In some embodiments, the composition and/or the biocomposite material further comprises about 0.5-about 5% a colorant, such as mineral and/or dye. In some embodiments, the composition comprises about 1% colorant.

In another aspect, the present invention provides a method of preparing a biodegradable biocomposite material of the present invention. The method comprises, admixing the polymer-component with hemp residue, and optionally with one or more compatibilizers and/or the compatibilizer-grafted PBAT described herein, and heating the admixture at a temperature sufficient to melt at least the PHVB and/or PBAT.

In some embodiments, the method comprises extruding the admixture at an extrusion temperature sufficient to melt at least the PHVB and/or PBAT. In some embodiments, the admixture is extruded via a screw extruder at a screw speed of about 80 to about 120 rpm, at a processing temperature of about 150° to about 220° C.

In some embodiments, the polymer-component and hemp residue are dried to remove residual moisture before processing. The drying can be achieved in a conventional oven at about 60-about 100° C., or via common industrial methods of drying, for example desiccant wheel dryer or a Munters desiccant wheel (at about 40-60C overnight).

In some embodiments, the produced biocomposite material is air-cooled and pelletized.

In some embodiments, the compatibilizer-grafted PBAT can be prepared by combining PBAT, the one or more compatibilizers, and a free radical initiator to form a reaction mixture, and melt processing the reaction mixture to form the grafted PBAT.

In some embodiments, PBAT is first mixed with one or more compatibilizers and heated to a temperature sufficient to melt at least one of the compatibilizer, followed by adding the free radical initiator prior to the melt processing.

In some embodiments, the melt processing is achieved at a temperature of about 150° to about 220° C.

In some embodiments, the melt processing comprises melt extrusion. In some embodiments, the melt extrusion is performed via a screw extruder at a screw speed of about 80-120 rpm, at a feed rate of about 300-750 g/h.

In some embodiments, the produced biocomposite is dried to remove unreacted compatibilizer.

In some embodiments, the biocomposite material of the present invention comprises PBAT grafted with one or more compatibilizers, which can be prepared by:
a) first preparing the grafted PBAT by combining PBAT with one or more compatibilizers and a free radical initiator to form a reaction mixture, and melt processing the reaction mixture to form the grafted-PBAT; and
b) then mixing the grafted-PBAT prepared in step a) with the polymer-component, hemp residue, and optional filler(s), and extruding the mixture at a processing temperature sufficient to melt at least the PHBV and/or PBAT.

In one aspect, the present invention provides a biocomposite material made by the methods described herein.

To gain a better understanding of the invention described herein, the following examples are set forth with reference to the accompanying drawings. It will be understood that these examples are intended to describe illustrative embodiments of the invention and are not intended to limit the scope of the invention in any way.

### EXAMPLES

### Example 1: Preparation of Hemp Powder (HP)

To produce the HP, the bast fiber was removed from the stalk and the remaining woody core (also called as hurd) and residual fiber was processed with a milling machine to prepare a fine powder of hemp hurd and residual fiber with micron-sized particles. The moisture content of the produced HP was less than 1.5%.

### Example 2: Preparation of MA-Grafted PBAT

An industry-viable melt extrusion technique was employed to produce MA-grafted PBAT (mPBAT). Initially, PBAT pellets were mixed with 5 wt. % maleic anhydride (MA) and stored in a hot air oven at 80° C. for about 30 min to melt the MA and create thin crust coating over PBAT pellets. The mixture was cooled mixed with 1 wt. % dicumyl peroxide (DCP) as a reaction initiator stirred before melt processing. The reactive extrusion was conducted in a twin-screw extruder (Process 11 Parallel Twin-Screw Extruder, Thermo Fisher Scientific) with a temperature profile of 130/135/140/150/150/140/135/130° C. from the die to feed was used, with a screw speed of 60 rpm (440 mm length, L/D of 40:1, and 11 mm in diameter), and feed rate of around 500 g/h. The produced mPBAT was then pelletized, weighed, and dried in a vacuum oven under a reduced pressure of 100 mbar and temperature of 80° C. for 24 h. Once the unreacted MA was removed from the sample, it was placed in an airtight container until further use.

### Example 3: Fabrication of Biocomposite Materials

PHBV-biocomposite or PHBV-PBAT-biocomposite with HP/mPBAT was prepared by first mixing the PHBV or a mixture of PHBV and PBAT with different concentrations of HP and mPBAT (weight percent) as shown in Table 1 and then drying in a hot-air oven at 80° C. overnight. The mixtures were extruded in a twin-screw extruder (Process 11 Parallel Twin-Screw Extruder, Thermo Fisher Scientific) at 180° C., with a screw speed of 100 rpm. The blends were injection molded using a HAAKE Mini-Jet Pro (Thermo Fisher Scientific, Waltham, MA, USA), using a cylinder temperature of 180° C., mold temperature of 60° C., and a pressure of 700 bar, held for 10 seconds. The specimens were further conditioned for 48 h at room temperature and 50% RH before testing.

TABLE 1
Ingredients of the Fabricated Biocomposite
Materials and their Nomenclature.

| | PHBV:PBAT | HP | mPBAT | |
|---|---|---|---|---|
| # | (matrix %) | (wt. %) | (wt. %) | Sample Name |
| 1. | 100:0 (100) | 0 | 0 | PHBV |
| 2. | 100:0 (90) | 10 | 0 | PHBV-10 HP |
| 3. | 100:0 (80) | 20 | 0 | PHBV-20 HP |
| 4. | 100:0 (70) | 30 | 0 | PHBV-30 HP |
| 5. | 100:0 (60) | 40 | 0 | PHBV-40 HP |
| 6. | 100:0 (50) | 50 | 0 | PHBV-50 HP |
| 7. | 100:0 (40) | 60 | 0 | PHBV-60 HP |
| 8. | 80:20 (100) | 0 | 0 | PHBV-PBAT (80:20) |
| 9. | 80:20 (90) | 10 | 0 | (80:20)-10 HP |
| 10. | 80:20 (80) | 20 | 0 | (80:20)-20 HP |
| 11. | 80:20 (70) | 30 | 0 | (80:20)-30 HP |
| 12. | 80:20 (60) | 40 | 0 | (80:20)-40 HP |
| 13. | 80:20 (50) | 50 | 0 | (80:20)-50 HP |
| 14. | 80:20 (40) | 60 | 0 | (80:20)-60 HP |
| 15. | 80:20 (90) | 0 | 10 | (80:20)-M |
| 16. | 80:20 (80) | 10 | 10 | (80:20)-10 HP-M |
| 17. | 80:20 (70) | 20 | 10 | (80:20)-20 HP-M |
| 18. | 80:20 (60) | 30 | 10 | (80:20)-30 HP-M |
| 19. | 80:20 (50) | 40 | 10 | (80:20)-40 HP-M |
| 20. | 80:20 (40) | 50 | 10 | (80:20)-50 HP-M |
| 21. | 80:20 (30) | 60 | 10 | (80:20)-60 HP-M |

### Characterization

Tensile testing was carried out using a Mandel-Shimadzu (AGS-X) tensile testing unit (Shimadzu Corp., Kyoto, Japan) equipped with 500 N load cell, with a crosshead speed of 5 mm/min and a gauge length of 25 mm across all samples. Five specimens were tested for each sample, and the average with standard deviation was reported as per ASTM D638 type V.

Dynamic mechanical analysis (DMA) was performed using a dynamic mechanical analyzer (Q800 DMA, TA Instruments). The samples were heated from −80° C. to 120° C. with a heating rate of 3° C./min. A dual cantilever clamp was used with a frequency of 1 Hz and strain of 0.2%.

The heat deflection temperature (HDT) of each blend was estimated using the dynamic mechanical analyzer (Q800 DMA, TA Instruments) with a three-point bending module and heating rate of 2° C./min. As mentioned in the ASTM 648-07 standard, Equation 1 was used to calculate the required force for each sample of this analysis,

$$F = \frac{2}{3} [ \frac{σ ( {H}^{2} \times W )}{L} ] \qquad ( 1 )$$

where σ is the stress on the specimen (0.455 MPa), and H, W and L are the height, width, and length of the specimen, respectively. The sample strain was calculated using Equation 2,

$$ε = 6 \times \frac{{( Deflection )}_{ASTM} \times {( Thickness )}_{ASTM}}{{( Length )}_{ASTM}^{2}} \qquad ( 2 )$$

where deflection (ASTM), thickness (ASTM) and length (ASTM) were taken as 0.25 mm, 13 mm, and 127 mm, as mentioned in the ASTM 648-07 standard. The estimated strain was then used to calculate the deflection using Equation 3.

$$D = ε \times \frac{{L}^{2}}{6 \times H} \qquad ( 3 )$$

with the deflection calculated, 166.3 μm, the HDT of each sample was estimated.

The rheology of the blends was studied using a parallel plate Rheometer (HAAKE MARS Ill, Thermo Fisher Scientific), with sample thickness and diameter of 1.55 mm and 20 mm, respectively. A frequency sweep of 0.01 to 100 Hz was performed at 200° C., with a constant strain of 0.1% (in the linear viscoelastic region) and a plate gap of 1 mm.

Scanning electron microscopy (SEM) was performed using an Oxford Instruments Quanta FEG 250 Environmental SEM (Abingdon, UK) without any sputter coating to examine the fractured surface morphologies of the blends. The micrographs were taken from cryo-fractured tensile samples to investigate the interaction of HP and polymer matrix.

A water absorption test was performed for 0, 10, 30 and 60% HP blends. Five specimens of each sample were first weighed and then submerged in 70 mL of distilled water in a glass container at room temperature. The weight of the specimens was recorded after 24 h, and further testing every four days afterwards.

Impact resistance of fabricated biocomposites was evaluated using an Izod type impact tester following ASTM D256. Tests were conducted using a TMI impact tester made by Testing Machines Inc. (Model 43-02) and an average of five specimens was reported with a standard deviation.

### Mechanical Properties of PHBV Based Biocomposite Materials

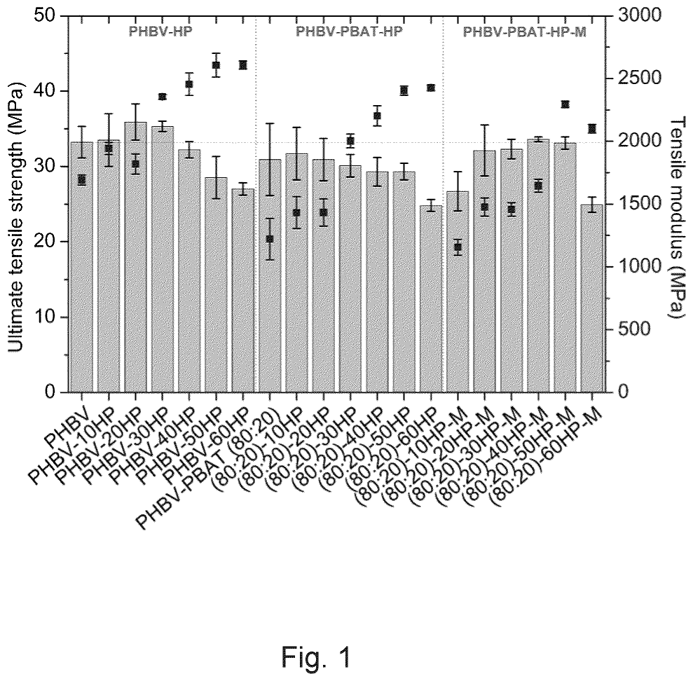

FIG. 1 depicts the ultimate tensile strength (UTS) and tensile modulus (TM) of the fabricated biocomposite materials. In PHBV, the UTS slightly increased from 33.2 MPa to 35.3 MPa upon the incorporation of 20% hemp residue powder (HP) that reduced to 27 MPa with the incorporation of 60% HP. It is believed that interfacial debonding of PHBV matrix and HP at higher concentration is mainly responsible for the early breakage of the specimen after unidirectional tensile pull. Also, localized accumulation of HP particles due to higher loading generates weak zones within the biocomposite which obstructs the proper load transfer resulting in reduced UTS. In the case of the PHBV-PBAT (80:20) matrix, the incorporation of 10% HP showed a slight improvement in UTS from 30.9 to 31.7 MPa, but further increase in the HP loading caused reduction to 24.8 MPa. As PBAT is a relatively soft material, it affects the UTS of PHBV-PBAT (80:20) biocomposite. Moreover, its phase separation and incompatibility with PBHV are also responsible for the UTS reduction. In the case of a blend of PHBV-PBAT with 10% maleated PBAT (mPBAT), incorporation of 50% HP result in further enhancement of UTS to 33.1 MPa. The use of 10% mPBAT acts as a compatibilizer between PBAT, PHBV, and HP. The functional mPBAT reacts with HP and produces PBAT grafted HP whereas partial reaction may happen with PHBV as well. Due to the incorporation of the mPBAT, the interfacial adhesion of HP with polymer matrix was improved and the compatibility of PBAT with PHBV was enhanced. Sufficient interfacial interaction of HP with the matrices resulted in elevated UTS, which was equivalent to pristine PHBV even after the addition of 50% HP loading.

The tensile modulus of the PHBV-HP gradually increased from 1,691 MPa to 2,609 MPa with an increase in the HP loading to 60%. The increased tensile modulus demonstrated the improvement in the stiffness of the developed biocomposites, which is a measure of resistance to applied unidirectional deformation. The addition of PBAT and mPBAT into the system with 60% HP resulted in a reduction in tensile modulus to 2,426 MPa and 2,100 MPa, respectively in comparison to the PHBV-60% HP. This was not surprising considering that PBAT is a soft and flexible polymer and its incorporation caused reduced stiffness. Comparatively, the addition of 60% HP along with PHBV-PBAT and mPBAT showed a tensile modulus higher than pristine PHBV. However, the incorporation of mPBAT contributes to the improvement in the impact resistance of the biocomposites.

### Elongation at Break and Izod Impact Resistance

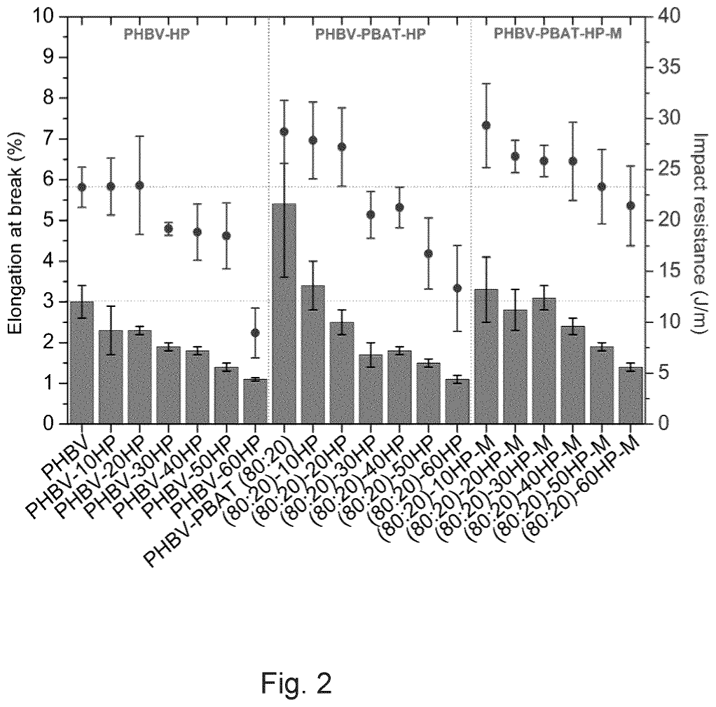

FIG. 2 depicts the elongation at break and Izod impact resistance of the developed biocomposites. It is known that the incorporation of a reinforcing agent or filler drastically reduces the elongation at the break or stretchability of the biocomposites. The elongation at break of the neat PHBV was ˜3% that reduced to ˜1% after the addition of 60% HP and a similar trend is observed in the case of PHBV-PBAT biocomposite. However, a comparable elongation at break to PHBV (˜3%) was observed with the incorporation of mPBAT with the use of 30% HP filler. The reactive extrusion of the biocomposites with mPBAT provided sufficient tensile toughness and relatively high elongation at break with the use of up to 30% HP. The reactive extrusion chemistry works with higher HP loading, which was signified by the obtained impact resistance data. The impact resistance of the PHBV-PBAT matrix with mPBAT and 50% HP (23.3 J/m) was equivalent to the impact resistance of the pristine PHBV (23.2 J/m). A reduced HP loading (20%) facilitated an increase in theimpact resistance (25.8 J/m).

### Thermomechanical Properties of PHBV Biocomposites

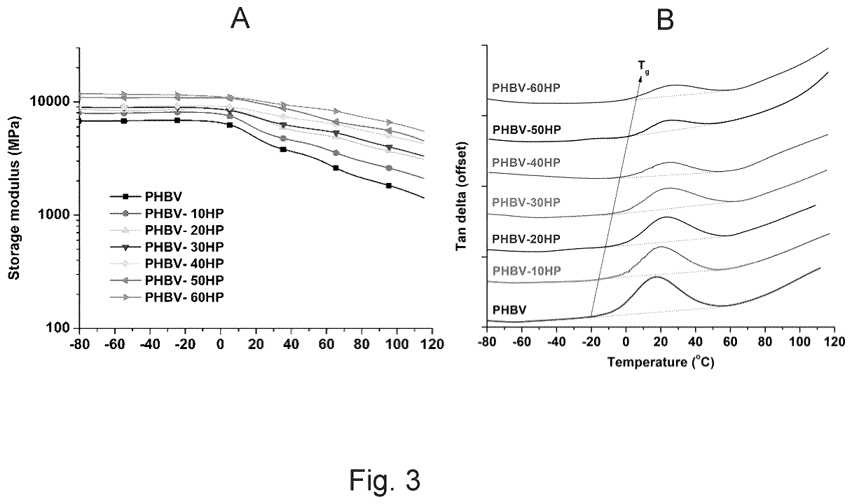

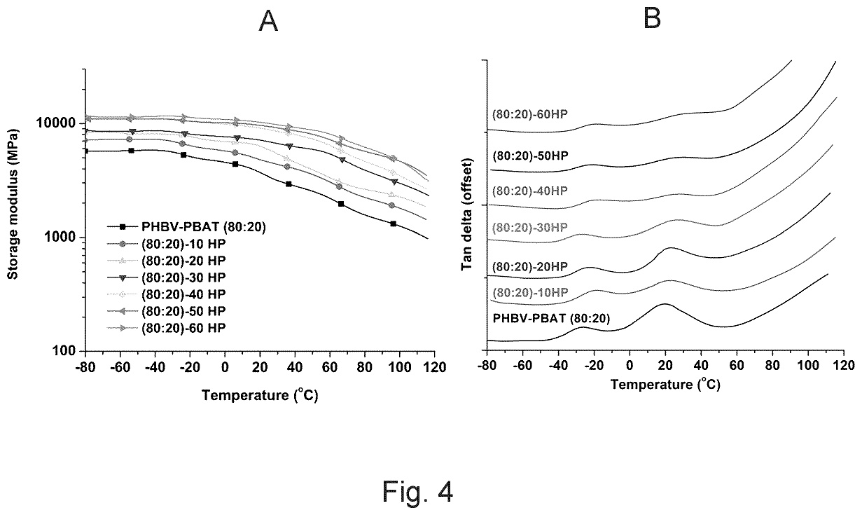

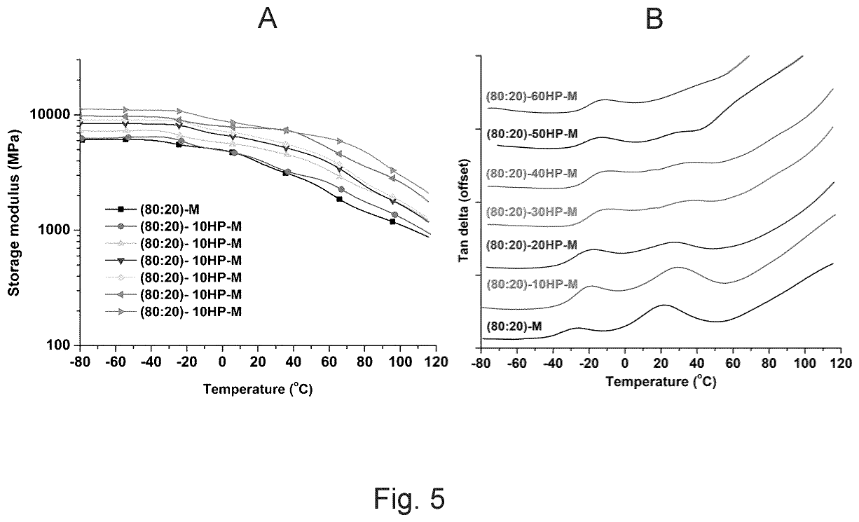

The dynamic mechanical properties of the various composite formulations were evaluated using DMA. The storage modulus of the specimens at −50° C., 0° C., 25° C., 50° C. are presented in Table 2 and the corresponding curves against temperature are presented in FIGS. 3A, 3B, 4A, 4B, 5A and 5B. As evident shown in Table 3 the incorporation of HP resulted in the enhancement of the storage modulus in all composite combinations. The storage modulus of PHBV at 25° C. (4359 MPa) improved by 127.5% to 9916 MPa with the addition of 60% HP, which indicated that the materials at 25° C. have elastic behavior which is improved after incorporation of HP. A similar trend was noted in the case of the PHBV-PBAT matrix. The increase in temperature to 50° C. did not have a significant effect on the storage modulus, which means that the fabricated materials maintained their elastic behavior in a larger temperature range.

The loss tangent (tan delta) of the biocomposites is also presented in Table 2. For PHBV, the tan delta peak was indicative of the glass transition that increased from ˜17° C. to ˜28° C. with the gradual increase in the HP loading to 60%. This reduction could be attributed to the reduction of the amorphous fraction in the biocomposites. The tan delta peaks height has also reduced indicating the chain mobility restrictions resulting from the stiff HP particles. In contrast, the PHBV-PBAT matrix displayed two distinct tan delta peaks at ˜20° C. and ˜27° C. corresponding to the glass transition of PHBV and PBAT, respectively. The incorporation of HP and mPBAT significantly shifted the tan delta peaks to higher temperatures and reduced the peak heights. The incorporation of mPBAT in highly filled (more than 30% HP) PHBV-PBAT matrix resulted in significant suppression of tan delta peaks showing improvement in the HP-matrix interfacial interaction. This was also confirmed by determining theoretical parameters used for the prediction of viscoelastic properties of developed biocomposites.

TABLE 2
Storage Modulus and Glass Transition Temperatures
of Developed Biocomposites using DMA

| | | | | | | Glass transition | |
|---|---|---|---|---|---|---|---|
| | Sample | Storage modulus (MPa) | | | | temperature (° C.) | |
| # | name | −50° C. | 0° C. | 25° C. | 50° C. | PHBV | PBAT |
| 1. | PHBV | 6633 | 6506 | 4359 | 3315 | 17.4 | — |
| 2. | PHBV- | 7941 | 7700 | 5270 | 4268 | 20.1 | — |
| | 10HP | | | | | | |
| 3. | PHBV- | 8310 | 8377 | 6786 | 5270 | 23.3 | — |
| | 20HP | | | | | | |
| 4. | PHBV- | 8823 | 8556 | 6930 | 5733 | 24.9 | — |
| | 30HP | | | | | | |
| 5. | PHBV- | 9233 | 8924 | 7864 | 6930 | 25.9 | — |
| | 40HP | | | | | | |
| 6. | PHBV- | 10718 | 10788 | 9308 | 7700 | 26.8 | — |
| | 50HP | | | | | | |
| 7. | PHBV- | 11585 | 11017 | 9916 | 8924 | 28.7 | — |
| | 60HP | | | | | | |
| 8. | PHBV- | 5768 | 4574 | 3405 | 2535 | 19.2 | −26.9 |
| | PBAT | | | | | | |
| | (80:20) | | | | | | |
| 9. | (80:20)- | 7273 | 5767 | 4574 | 3552 | 21.8 | −20.6 |
| | 10HP | | | | | | |
| 10. | (80:20)- | 8253 | 6972 | 5890 | 3947 | 22.3 | −21.9 |
| | 20HP | | | | | | |
| 11. | (80:20)- | 8609 | 7586 | 6973 | 5890 | 26.3 | −26.1 |
| | 30HP | | | | | | |
| 12. | (80:20)- | 10628 | 9769 | 8792 | 7273 | 27.2 | −17.9 |
| | 40HP | | | | | | |
| 13. | (80:20)- | 10855 | 10189 | 9366 | 8081 | 29.2 | −19.6 |
| | 50HP | | | | | | |
| 14. | (80:20)- | 11322 | 10855 | 10189 | 8792 | 31.3 | −17.8 |
| | 60HP | | | | | | |
| 15. | (80:20)-M | 6048 | 4899 | 3571 | 2549 | 20.6 | −27.4 |
| 16. | (80:20)- | 6443 | 5004 | 3804 | 2893 | 28.8 | −19.6 |
| | 10HP-M | | | | | | |
| 17. | (80:20)- | 7211 | 5678 | 5003 | 3885 | 27.6 | −18.3 |
| | 20HP-M | | | | | | |
| 18. | (80:20)- | 8473 | 6720 | 5677 | 4409 | 35.3 | −10.1 |
| | 30HP-M | | | | | | |
| 19. | (80:20)- | 9026 | 7159 | 6177 | 4899 | 38.6 | −10.9 |
| | 40HP-M | | | | | | |
| 20. | (80:20)- | 9615 | 7954 | 7467 | 6048 | 38.6 | −12.6 |
| | 50HP-M | | | | | | |
| 21. | (80:20)- | 11143 | 9026 | 7788 | 6720 | 42.3 | −11.3 |
| | 60HP-M | | | | | | |

### Storage Modulus of PHBV Biocomposites

To predict the storage modulus in the presence of HP, the effectiveness coefficient factor and reinforcing efficiency factor were employed. Equestion 4 proposed by Einstien [7] can be utilized to evalute filler reinforcement by calculating the reinforcement efficiency factor (r).

E_{c}=Eₘ(1+rV_{f}) (4)

Where E_{c} and Eₘ represent the storage modulus of the biocomposite and matrix, respectively and V_{f} is the volume fraction of the filler.

The filler loading levels and its dispersion affect the reinforcing efficiency factor (r), which can be obtained from a linear plot of E_{c}/Eₘ vs V_{f}. Higher value of r corresponds to the lower agglomeration and homogeneous dispersion. The calculated values of r for the various biocomposites are listed in Table 3. The r value of PHBV-HP, PHBV-PBAT-HP and PHBV-PBAT-HP-M biocomposites were 1.47, 1.81, and 1.85, respectively. The higher r values were obtained for composites that contain mPBAT indicating enhanced reinforcement mediated by the improved dispersion of the HP in such formultions. Furthermore, the value of r was used to theorotically calculate the storage modulus of the respective biocomposite and was found to be within the errors of margin from the experimental value (Table 3).

Since storage modulus corresponds to stored energy in the biocomposites, an increase in temperature affects its value due to the molecular movement of the polymer chains and molecular frequency. The incorporation of HP enhanced the storage modulus of the respective specimens due to the chain mobility restriction by the stiff HP. The effectiveness of the filler can be evaluated by calculating the effectiveness coefficient of the reinforcement (C) which was estimated using Equation 5[8].

$$C = \frac{( \frac{{R}_{g}}{{E}_{r}} ) composite}{( \frac{{E}_{g}}{{E}_{r}} ) matrix} \qquad ( 5 )$$

where E_{g} and Eᵣ are the storage modulus in the glassy region (−20° C.) and rubbery region (120° C.), respectively.

The obtained value of C is listed in Table 3. Lower value of C is indicative of maximum stress transfer between the matrix and filler. In this study, it was noted that the value of C has reduced in all formulations that involve HP indicating the optimal stress transfer.

TABLE 3
Theoretical Parameters for the Prediction of Viscoelastic
Properties of the Developed Biocomposites

| | Sample | | | | | |
|---|---|---|---|---|---|---|
| # | name | V_{f} | C | r | E_{M} | E_{T} |
| 01. | PHBV | 0 | — | 1.4743 | 6809.8 | — |
| 02. | PHBV- | 7.9 | 0.8699 | | 7957.1 | 7600.3 |
| | 10HP | | | | | |
| 03. | PHBV- | 15.8 | 0.8272 | | 8359.4 | 8390.9 |
| | 20HP | | | | | |
| 04. | PHBV- | 23.6 | 0.5903 | | 8911.8 | 9181.4 |
| | 30HP | | | | | |
| 05. | PHBV- | 31.5 | 0.5262 | | 10085.8 | 9971.9 |
| | 40HP | | | | | |
| 06. | PHBV- | 39.4 | 0.5020 | | 10678.7 | 10762.4 |
| | 50HP | | | | | |
| 07. | PHBV- | 47.2 | 0.4622 | | 11632.4 | 11553.0 |
| | 60HP | | | | | |
| 08. | PHBV- | 0 | — | 1.8097 | 5801.3 | — |
| | PBAT | | | | | |
| | (80:20) | | | | | |
| 09. | (80:20)- | 7.9 | 0.8752 | | 6401.1 | 6628.0 |
| | 10HP | | | | | |
| 10. | (80:20)- | 15.8 | 0.7791 | | 7253.2 | 7454.6 |
| | 20HP | | | | | |
| 11. | (80:20)- | 23.6 | 0.6955 | | 8178.2 | 8281.3 |
| | 30HP | | | | | |
| 12. | (80:20)- | 31.5 | 0.6830 | | 8798.1 | 9107.9 |
| | 40HP | | | | | |
| 13. | (80:20)- | 39.4 | 0.5078 | | 10038.9 | 9934.6 |
| | 50HP | | | | | |
| 14. | (80:20)- | 47.2 | 0.5297 | | 11037.3 | 10761.3 |
| | 60HP | | | | | |
| 15. | (80:20)- | 7.9 | 0.9148 | 1.8461 | 6316.7 | 6644.6 |
| | 10HP-M | | | | | |
| 16. | (80:20)- | 15.8 | 0.8595 | | 7913.2 | 7487.9 |
| | 20HP-M | | | | | |
| 17. | (80:20)- | 23.6 | 0.8504 | | 8215.5 | 8331.2 |
| | 30HP-M | | | | | |
| 18. | (80:20)- | 31.5 | 0.8417 | | 8967.1 | 9174.5 |
| | 40HP-M | | | | | |
| 19. | (80:20)- | 39.4 | 0.6848 | | 9914.1 | 10017.8 |
| | 50HP-M | | | | | |
| 20. | (80:20)- | 47.2 | 0.6636 | | 11056.4 | 10861.0 |
| | 60HP-M | | | | | |

Density of HP: 1.27 g/cm³,
V_{f}: volume Fraction of HP (%),
C: effectiveness coefficient factor,
r: reinforcing efficiency factor,
E_{M}: Experimental modulus (MPa),
E_{T}: theoretical modulus (MPa)

### Heat Resistance of PHBV Biocomposites

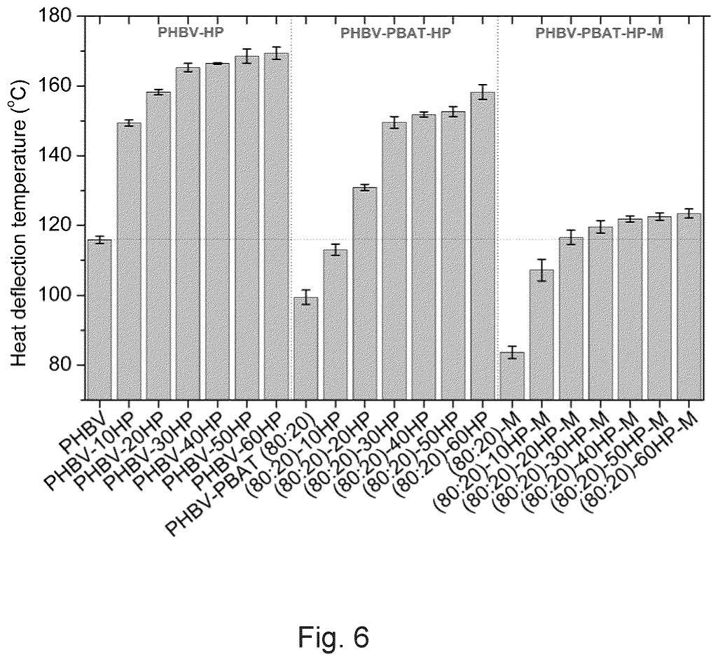

From the packaging application point of view, the heat resistance of biocomposites is a crucial parameter, especially for hot beverage and warm product packaging and containment applications. It can be quantitatively evaluated by measuring the heat deflection temperature (HOT). FIG. 6 displays the heat deflection temperature (HOT) of the composite formulations. The HOT of pristine PHBV was 116° C. which increased to 170° C. after the addition of 60% HP. The incorporation of HP restricts the polymer chains mobility even at higher temperatures and resist the deformation upon loading. In contrast, adding the softer PEAT reduces the HOT value to −157° C. which resulted from the enhanced chain movement of the overall composite and reduction in load carring capacity at a higher temperature. It is known that the compatibilizer mPBAT contains lower molecular weight polymer chains and its use may contribute to the reduction in HDT. However, after the addition of 60% HP in PHBV-PBAT in presence of mPBAT exhibited an HDT of more than 120° C., which was higher than the pristine PHBV. Overall, the heat resistance of the biocomposites is maintained even after the incorporation of high loading HP (60%).

### Rheological Properties of PHBV Biocomposites

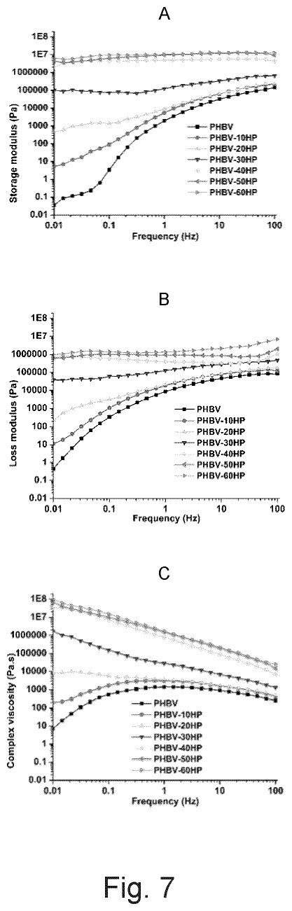

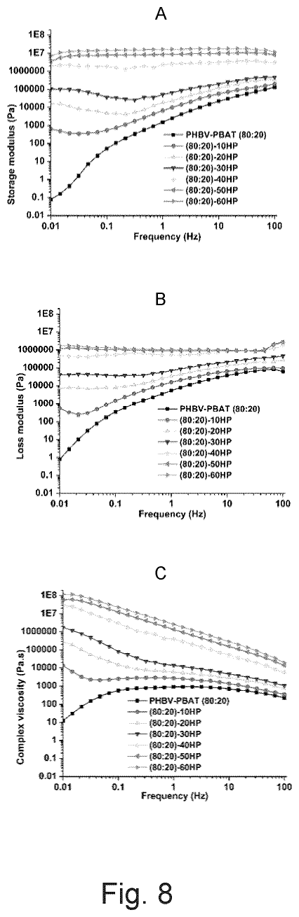

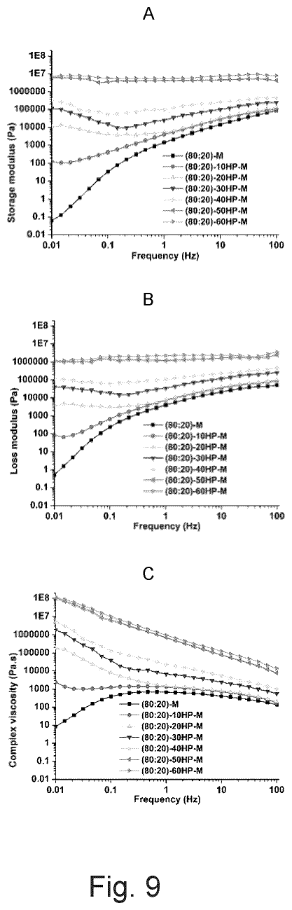

A parallel plate rheomet is used to determine the dynamic rheological properties of the developed biocomposites. The corresponding storage modulus, loss modulus and complex viscosities are shown in FIGS. 7A-7C, 8A-8C and 9A-9C against frequency. It was noted that the storage modulus of the composites increased up on the incorporation of HP, suggesting the material's elastic behavior. Similar trend was found for loss modulus of the biocomposite samples. As melt processing of materials need a specific threshold of viscosity, knowing the effect of the HP compositions on the melt viscosity has paramount importance. The incorporation of 60% HP in only PHBV matrix result in complex viscosity of 1.8 MPa·s at 1 Hz frequency (equivalent to 60 rpm) which is increase to 2.6 MPa·s due to higher chain entanglement of PBAT molecules. However, the incorporation of mPBAT in the biocomposite result in reduced complex viscosity to 1.02 MPa·s, which was mainly due to the presence of low molecular weight PBAT chains and wetting of HP that facilitated chain sliding over its surface and reduce the molecular friction forces. Overall, the reduce complex viscosities of the developed formulation helps to generate a smooth melt extrusion processing without reaching threshold screw torque.

### Water Absorption of PHBV Biocomposites

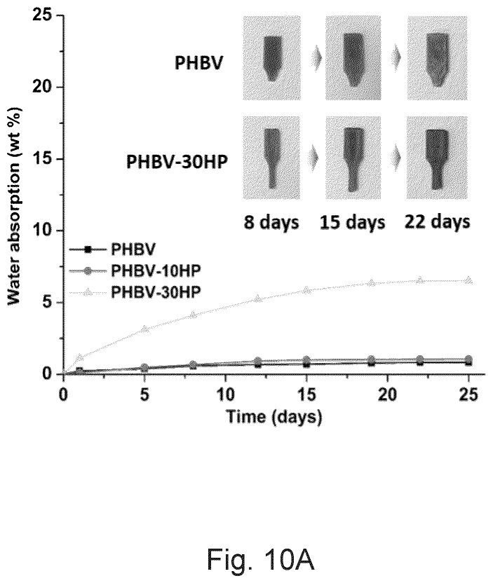

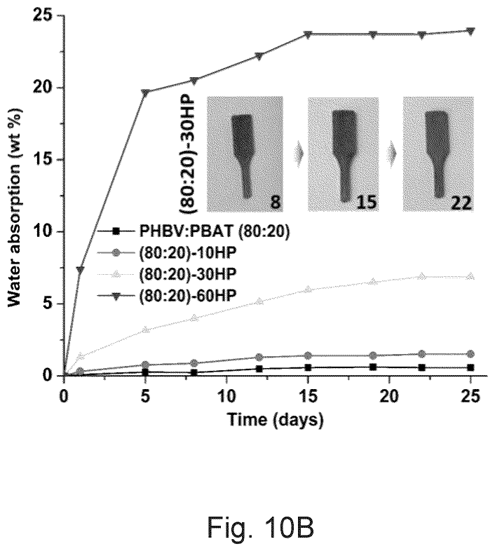

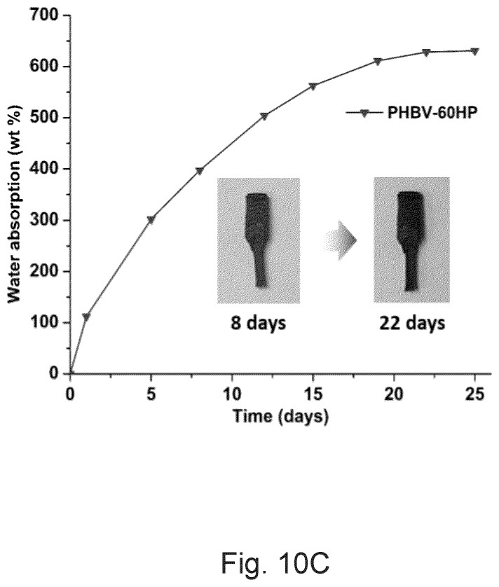

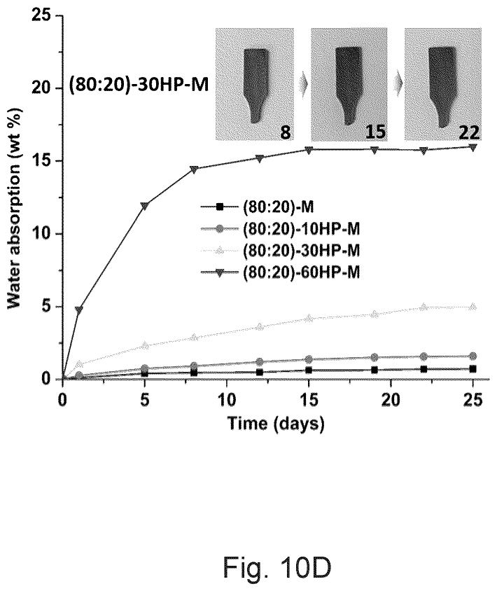

It is know that most lignocellulosic bio-fillers are inherently hydrophilic and absorb a substantial amout of moisture. HP, being a lignocellulosic material, is also expected to have high moisture absorption that can be carried over to the PHBV-PBAT composites. Since water absorption is directly linked to dimensional stability of the final biocomposite products, it is essential to understand the water absorption behavior and their effect on the biocomposites. A plot of water absorption percentage against time in days is given in FIGS. 10A-10D. In the case of PHBV, a clear increase in the moisture absorption with an increase in the HP loading was noted. In contrast, biocomposite with PHBV-PBAT matrix exhibited relatively lower moisture absorption at higher HP loading, which suggested that the presence of PBAT developed a coating on the hemp powder surface and prevent it from water absorption. Furthermore, the use of an mPBAT compatibilizer that formed a chemical bond with HP particles avert the water molecule diffusion and its direct access to HP particles.

In the terms of moisture absorption, water molecules can penetrate the surface via different mechanisms such as capillary transport through micro-gaps, diffusion through micro-gaps between polymeric chains, and diffusion through gaps between bio-fillers and polymeric domains. However, diffusion through micro-gaps between bio-filler and polymeric domains is the most prominent reason for water absorption. Mainly, water molecules can absorbed by bio-fillers directly by means of the formation of hydrogen bonding and through interface between bio-filler and the matric. The use of mPBAT as compatibilizer develop a coating over HP which prevent direct access of HP by water molecules. Moreover, the chemical bonding between mPBAT and HP improves the interfacial adhesion between bio-fillers and matrix (also confirmed by SEM microscopic analysis of fractured surfaces) that ultimately significantly reduce the diffusion of water molecules through interface. Overall, the use of mPBAT compatibilizer is not only effective for mechanical properties improvement, it also equally important to prevent moisture absorption mainly for biocomposite with higher loading.

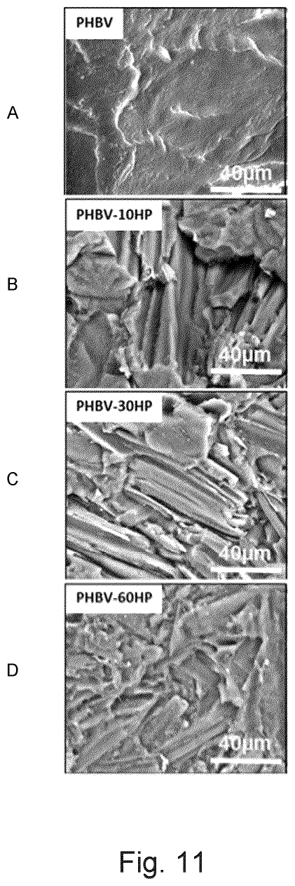

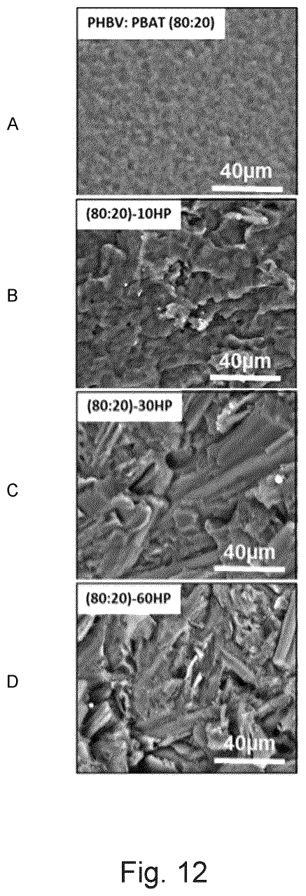

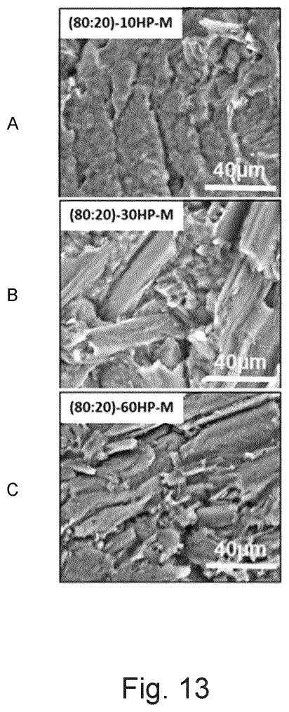

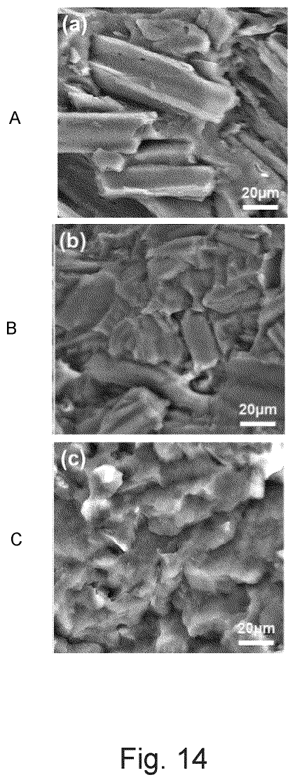

It is understood from the discussions in previous section that the incorporation of mPBAT in PHBV-PBAT HP results in relatively toughened and low water abosrption biocomposites. Formulation developed in this study is consequence in biocomposite with the similar properties of pristine PHBV. The reaction of mPBAT with HP and limited reaction with PHBV during the reactive extrusion process led to an anchor effect in which PBAT chains connected with HP interacts with PHBV-PBAT matrix and increase the interfacial interaction of HP with other polymeric chains. The morphology images of fractured surfaces of pristine matrix and its biocomposites with 10%, 30% and 60% HP loading are shown in FIGS. 11A-11D, 12A-12D and 13A-13D. Morphological analysis of these polymers and composites suggests proper dispersion of the filler. Wetting of HP with polymer chains can be seen in FIGS. 14A-14C. In the case of PHBV-30 HP biocomposites, HP is completely exposed outside of the matrix that shows the lower interfacial adhesion. Whereas, in case of the (80:20)-M with 30% HP, it can be seen that the filler particles are completely coated with polymer domains, which help in stress transfer upon applied force. This improved interfacial interaction is responsible for the stress transfer between the matrix and filler which resulted in improved mechanical strength and modulus along with impact strength and reduced water abosrption.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

### CITED REFERENCES

[1] A. Chamas, H. Moon, J. Zheng, Y. Qiu, T. Tabassum, J. H. Jang, M. Abu-Omar, S. L. Scott, S. Suh, Degradation Rates of Plastics in the Environment, ACS Sustainable Chemistry & Engineering 8(9) (2020) 3494-3511.
[2] A. E. Schwarz, T. N. Ligthart, E. Boukris, T. van Harmelen, Sources, transport, and accumulation of different types of plastic litter in aquatic environments: A review study, Marine Pollution Bulletin 143 (2019) 92-100.
[3] K. Pabortsava, R. S. Lampitt, High concentrations of plastic hidden beneath the surface of the Atlantic Ocean, Nature Communications 11(1) (2020) 4073.
[4] J. N. Hahladakis, E. lacovidou, An overview of the challenges and trade-offs in closing the loop of post-consumer plastic waste (PCPW): Focus on recycling, Journal of Hazardous Materials 380 (2019) 120887.
[5] K. W. Meereboer, M. Misra, A. K. Mohanty, Review of recent advances in the biodegradability of polyhydroxyalkanoate (PHA) bioplastics and their composites, Green Chemistry 22(17) (2020) 5519-5558.
[6] K. Ghosh, B. H. Jones, Roadmap to Biodegradable Plastics-Current State and Research Needs, ACS Sustainable Chemistry & Engineering 9(18) (2021) 6170-6187.
[7] J. Topping, Investigations on the Theory of the Brownian Movement, Physics Bulletin 7(10) (1956) 281-281.
[8] D. Romanzini, A. Lavoratti, H. L. Ornaghi, S. C. Amico, A. J. Zattera, Influence of fiber content on the mechanical and dynamic mechanical properties of glass/ramie polymer composites, Materials & Design 47 (2013) 9-15.

1. A composition for use in making a biodegradable biocomposite material, the composition comprising:
a) about 30 wt % to about 99.5 wt % of a polymer-component comprising poly(3-hydroxybutyrate-co-3-hydroxyvalerate) (PHBV) or a mixture of PHBV and polybutylene adipate terephthalate (PBAT);
b) about 0.5 wt % to about 60 wt % of hemp residue comprising ground hemp stalk wherein the hemp hurd and/or fibers are ground and/or sliced into micron size particles; and
c) optionally about 0.1 wt % to about 50 wt % of:
PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or
one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid.

2. The composition of claim 1, wherein the polymer-component is poly(3-hydroxybutyrate-co-3-hydroxyvalerate) (PHBV).

3. The composition of claim 1, wherein the polymer-component is the mixture of PHBV and polybutylene adipate terephthalate (PBAT).

4. The composition of claim 3, wherein the PHBV-PBAT mixture comprises about 10 wt %-to about 90 wt % of PHBV and about 90 to about 10 wt % of PBAT by total weight of the mixture.

5. The composition of claim 3, wherein the PHBV-PBAT mixture comprises about 50 wt % to about 90 wt % of PHBV and about 50 to about 10 wt % of PBAT by total weight of the mixture.

6. The composition of claim 1, wherein the composition comprises about 40 wt % to about 90 wt % polymer-component and about 10 wt % to about 60% hemp residue.

7. The composition of claim 1, wherein the composition comprises about 5% wt % to 20 wt % of the PBAT grafted with the one or more compatibilizers.

8. The composition of claim 1, wherein the hemp residue comprises particles having an length of about 75 to about 150 μm, and an average aspect ratio of about 3.5 to about 5.

9.-11. (canceled)

12. The composition of claim 1, further comprising about 1 to about 3% by weight of a processing agent, and/or one or more inorganic fillers.

13.-14. (canceled)

15. A biocomposite material comprising a blend of:
a) about 30 wt % to about 99.5 wt % of polymer-component comprising poly(3-hydroxybutyrate-co-3-hydroxyvalerate) (PHBV) or a mixture of PHBV and polybutylene adipate terephthalate (PBAT);
b) about 0.5 wt % to about 60 wt % of hemp residue comprising ground hemp stalk wherein the hemp hurd and/or fibers are ground and/or sliced into micron size particles; and
c) optionally about 0.1 wt % to 50 wt % of:
PBAT grafted with one or more compatibilizes selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and copolymers of acrylic acid, and/or
one or more compatibilizers selected from maleic anhydride, pyromellitic anhydride, acrylic acid; polyacrylic acid, and methylene diphenyl diisocyanate,
wherein the mixture has been heated.

16. The biocomposite material of claim 15, wherein the polymer-component is poly(3-hydroxybutyrate-co-3-hydroxyvalerate) (PHBV).

17. The biocomposite material of claim 15, wherein the polymer-component is the mixture of PHBV and polybutylene adipate terephthalate (PBAT).

18. The biocomposite material of claim 17, wherein the PHBV-PBAT mixture comprises about 5 wt % to about 95 wt % of PHBV and about 95 wt % to about 5 wt % of PBAT by total weight of the blend.

19. The biocomposite material of claim 17, wherein the PHBV-PBAT mixture comprises about 50 wt % to about 90 wt % of PHBV and about 50 wt % to about 10 wt % of PBAT by total weight of the blend.

20. The biocomposite material of claim 15, wherein the composition comprises about 40 wt % to about 90 wt % of the polymer-component and about 10 wt % to about 60 wt % hemp residue.

21. The biocomposite material of claim 20, wherein the composition comprises about 5 wt % to 20% wt % of the PBAT grafted with the one or more compatibilizers.

22. The biocomposite material of claim 15, wherein the hemp residue comprises particles having a length of about 75 to about 150 μm, and an average aspect ratio of about 3.5 to about 5.

23.-25. (canceled)

26. The biocomposite material of claim 15, further comprising about 1 to about 3% by weight of a processing agent, and/or one or more inorganic fillers.

27. (canceled)

28. A method of preparing a biocomposite material as defined in claim 15, the method comprising:
a) admixing the polymer-component with the hemp residue, and optionally with the one or more compatibilizers and/or the PBAT grafted with one or more compatibilizers, and
b) heating the admixture at a temperature sufficient to melt at least the PHBV and/or PBAT.

29. The method of claim 28, wherein heating the admixture comprises extruding the admixture at an extrusion temperature sufficient to melt at least the PHBV and/or PBAT.

30. The method of claim 29, wherein the admixture is extruded via a screw extruder with a screw speed of about 80 to about 120 rpm, at a processing temperature of about 150° to about 220° C.

31. A method of claim 28, wherein the composite material comprises the compatibilizer-grafted PBAT and the method further comprises:
preparing the compatibilizer-grafted PBAT, by combining PBAT, the one or more compatibilizers, and a free radical initiator to form a reaction mixture, and melt processing the reaction mixture to form the compatibilizer-grafted PBAT.

32. (canceled)
